(19) United States
(12) Patent Application Publication
(10) Pub. No.: US 2015/0046258 A1
(43) Pub. Date: Feb. 12, 2015

(54) COMMUNICATIONS SYSTEM PROVIDING MOBILE DEVICE ADVERTISMENTS BASED UPON ACTIVITY HISTORY AND RELATED METHODS

(71) Applicant: BlackBerry Limited, Waterloo (CA)

(72) Inventors: Jason Tyler GRIFFIN, Kitchener (CA); Gerhard Dietrich Klassen, Waterloo (CA); Scott David Reeve, Waterloo (CA); Sherryl Lee Lorraine Scott, Etobicoke (CA)

(21) Appl. No.: 14/527,265

(22) Filed: Oct. 29, 2014

Related U.S. Application Data
(63) Continuation of application No. 12/394,103, filed on Feb. 27, 2009, now abandoned.

(51) Int. Cl. G06Q 30/02; H04M 3/487; H04W 4/02

(52) U.S. Cl. CPC G06Q 30/0255; H04W 4/028; H04M 3/4878; G06Q 30/0267
USPC 705/14.53

(57) ABSTRACT

A communications system may include at least one mobile wireless communications device and an advertising server cooperating with the at least one mobile wireless communications device via a wireless communications network. The advertising server may be for generating an activity history for the at least one wireless communications device including geographical positions at corresponding times of day, and selectively sending advertisements to the at least one mobile wireless communications device based upon the activity history and a given time of day.

### TECHNICAL FIELD

The present disclosure relates to the field of communications systems, and, more particularly, to mobile wireless communications systems and related methods.

### BACKGROUND

Mobile communications systems continue to grow in popularity and have become an integral part of both personal and business communications. Mobile telephones allow users to place and receive voice calls most anywhere they travel. Moreover, as mobile telephone technology has increased, so too has the functionality of mobile devices and the different types of devices available to users. For example, many mobile devices now incorporate personal digital assistant (PDA) features such as calendars, address books, task lists, etc. Moreover, such multi-function devices may also allow users to wirelessly send and receive electronic mail (email) messages and access the Internet via a cellular network and/or a wireless local area network (WLAN), for example.

As a result, users continue to spend more time using their mobile devices during the course of a day, as opposed to early cellular phones that were used only for phones calls. This has resulted in a significant interest from the advertising community in targeting advertisements to mobile devices.

### BRIEF DESCRIPTION OF THE DRAWINGS

FIG. 1 is a schematic block diagram of a communications system in accordance with one exemplary embodiment providing mobile wireless communications device advertising based upon activity history.

FIGS. 2 and 3 are schematic block diagrams illustrating advertisement selection features in various embodiments of the system of FIG. 1.

FIG. 4 is a schematic block diagram illustrating mobile wireless communications device geographical positioning determining techniques that may be used in accordance with the system of FIG. 1.

FIG. 5 is a flow diagram illustrating communications method aspects in accordance with an exemplary embodiment.

FIG. 6 is a schematic block diagram illustrating exemplary components of a mobile wireless communications device that may be used for determining vehicle traffic rate or density, or passing pedestrian traffic density, in accordance with exemplary embodiments.

### DETAILED DESCRIPTION

The present description is made with reference to the accompanying drawings, in which various embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

Generally speaking, a communications system is disclosed herein which may include at least one mobile wireless communications device and an advertising server cooperating with the at least one mobile wireless communications device via a wireless communications network. More particularly, the advertising server may be configured to generate an activity history for the at least one wireless communications device including geographical positions at corresponding times of day, and selectively sending advertisements to the at least one mobile wireless communications device based upon the activity history and a given time of day.

The advertising server may generate the activity history based upon activity within a home geographical region, and if the at least one mobile wireless communications device is outside of the home geographical region then selectively send advertisements relating to historical activities within the home geographical region at the given time of day. More particularly, if the at least one mobile wireless communications device is outside of the home geographical region, then the advertising server may be configured to further determine whether the at least one mobile wireless communications device is in a business geographical location or a vacation geographical location, and further selectively send the advertisements based thereon. By way of example, the advertising server may be configured to selectively send entertainment-related advertisements when the at least one mobile wireless communications device is in the vacation geographical location, and selectively send work-related advertisements when the at least one mobile wireless communications device is in the business geographical location. Further, the advertising server may be configured to selectively send the advertisements also based upon current events at a location of the at least one mobile wireless communications device.

By way of example, the at least one mobile wireless communications device may include a satellite positioning system, and the advertising server may be configured to determine the geographical positions based upon the satellite positioning system. In some embodiments, the at least one mobile wireless communications device may be a cellular device, and the wireless communications network may be a cellular network including a plurality of base stations. As such, the advertising server may be configured to determine the geographical positions based upon a given base station communicating with the cellular device.

A related advertising server may include an activity history module configured to generate an activity history for the at least one wireless communications device including geographical positions at corresponding times of day. The advertising server may further include an advertising module configured to cooperate with the activity history module to selectively send advertisements to the at least one mobile wireless communications device based upon the activity history and a given time of day.

A related communications method may include generating an activity history for at least one wireless communications device including geographical positions thereof at corresponding times of day, and selectively sending advertisements to the at least one mobile wireless communications device based upon the activity history and a given time of day.

A related computer-readable medium is also provided. The computer-readable medium may have computer-executable instructions for causing a computer to perform steps including generating an activity history for at least one wireless communications device including geographical positions thereof at corresponding times of day, and selectively sending advertisements to the at least one mobile wireless communications device based upon the activity history and a given time of day.

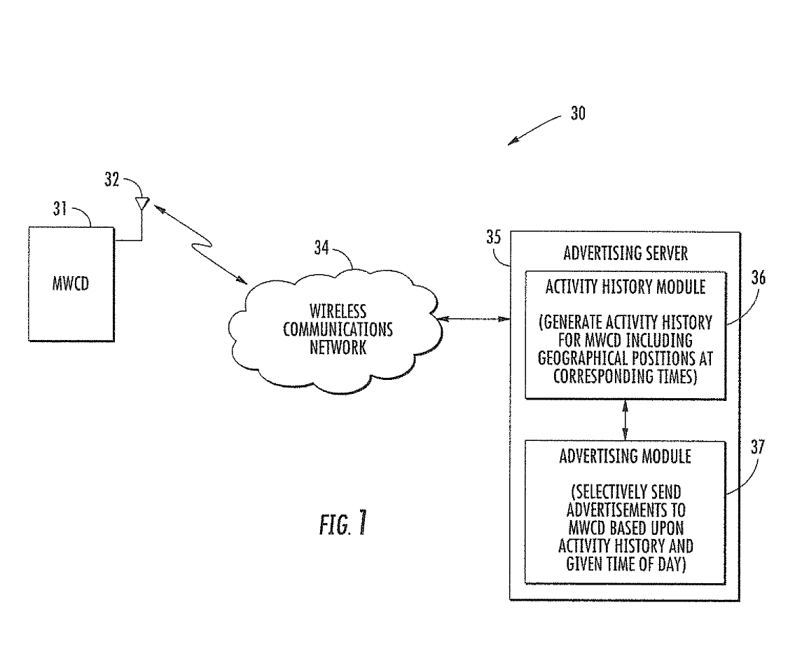

Turning now to FIGS. 1-5, a communications system 30 and associated communications method aspects are first described. The system 30 illustratively includes one or more mobile wireless communications devices 31 (MWCDs) and associated antenna(s) 32, which may include internal antennas, external antennas, or both. Moreover, the system 30 further illustratively includes a wireless communications network 34, and an advertising server 35 that communicates with the device 31 via the wireless communications network.

By way of example, the device 31 and wireless communications network 34 may operate in accordance with a cellular, wireless LAN (e.g., 802.11x, Bluetooth, etc.), WiMAX, satellite, etc., communications format, as will be appreciated by those skilled in the art. In some embodiments, more than one such wireless communications format may be used in the same device (e.g., cellular, wireless LAN, and Bluetooth). Various types of mobile wireless communications devices 31 may be used, such as mobile phones, PDAs, laptop computers, wireless-enabled cameras, wireless-enabled media players, etc., for example.

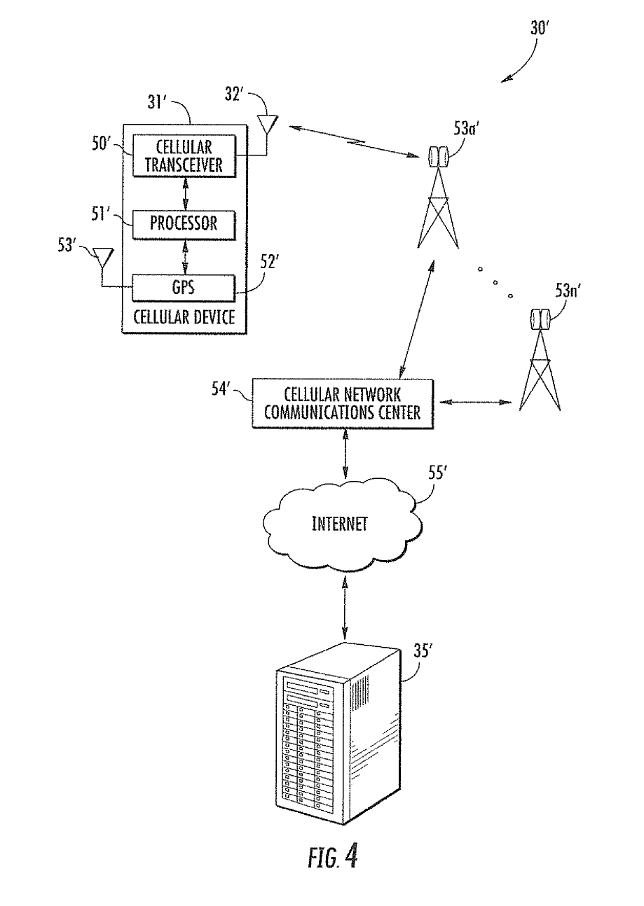

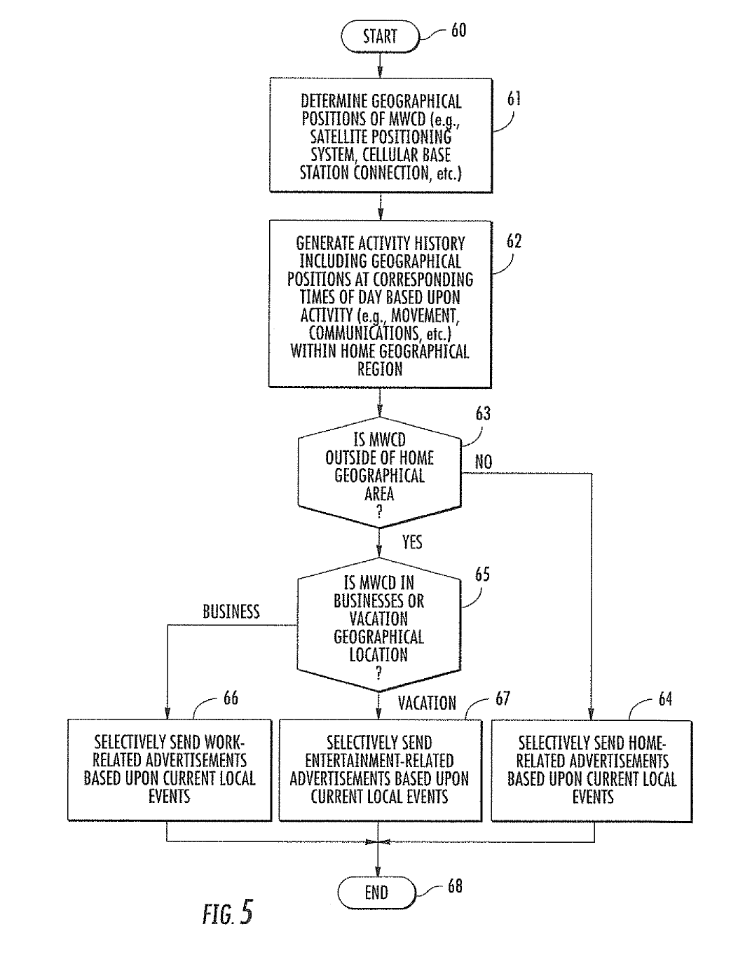

The advertising server 35 illustratively includes an activity history module 36 for generating an activity history for the mobile wireless communications device 31 including geographical positions at corresponding times of day, at Blocks 60-62 (FIG. 5). Determination of the geographical position where the device 31 is located may be accomplished though a variety of techniques. For devices 31 that include a satellite positioning system, such as a global positioning system (GPS) 52′ and accompanying antenna(s) 53′ shown in FIG. 4, position information (e.g., latitude/longitude coordinates, etc.) may be downloaded from the device 31′. Other suitable positioning systems (e.g., Galileo, GLONASS, Beidou, IRNSS, etc.) may also be used.

More particularly, in the illustrated example the device 31′ is a cellular device including a cellular transceiver 50′ and associated antenna 32′, and a processor or controller 51′ (e.g., a microprocessor and associated memory, computer executable instructions, etc.) illustratively coupled to the transceiver and the GPS 52′. In such an embodiment, the device 31′ communicates over a cellular communications network which illustratively includes a plurality of cellular base stations 53a′-53n′ (shown as cellular towers in the example of FIG. 4) and a cellular network communications center 54′, which switches telephone calls between the various base stations and a public switched telephone network (PSTN), for example, as will be appreciated by those skilled in the art. Moreover, the cellular network communications center 54′ may also route data, such as electronic mail (email) data, Internet data, etc., to and from devices 31′ over the Internet 55′, and particularly to and from the advertising server 35′.

It should be noted that the geographical position information may be determined using other approaches than a satellite positioning system resident on the device 31′. For example, the position of the device 31′ may be determined based upon the particular base station 53′ communicating with the device, or by triangulation using a plurality of base stations, as will be appreciated by those skilled in the art.

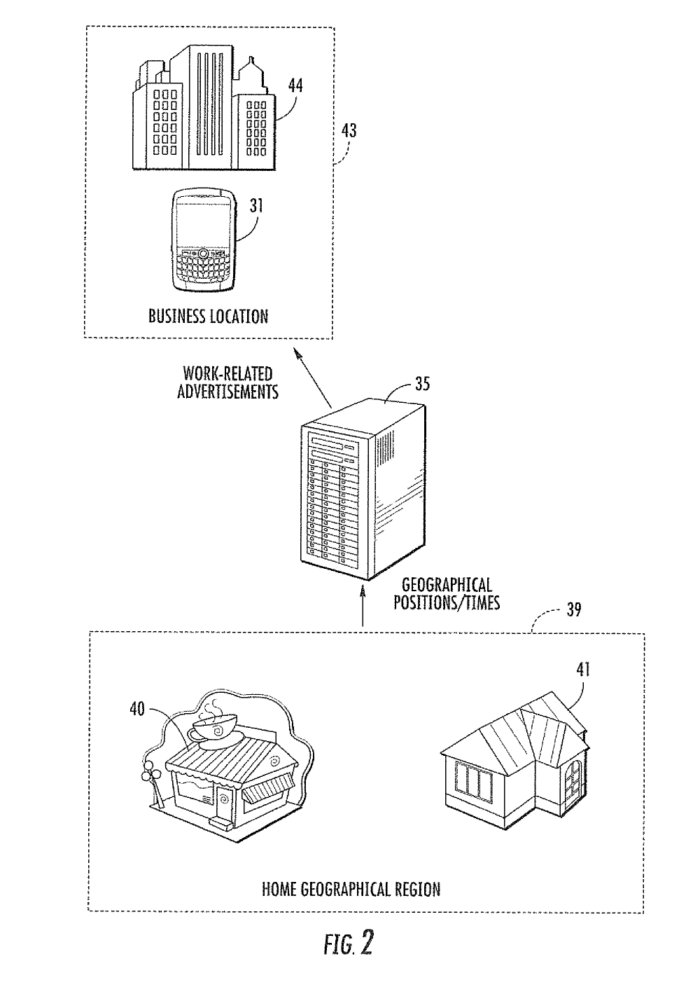

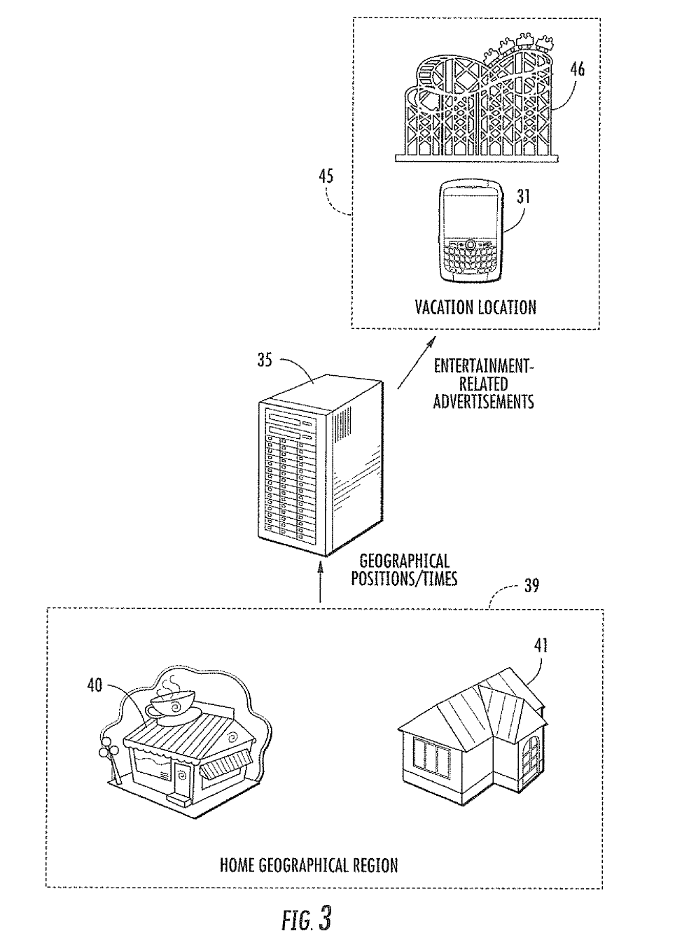

Referring to the example of FIGS. 2 and 3, each mobile wireless communications device 31 may have a home geographical region 39 associated therewith. In the case of a cellular device, for example, the home geographical region 39 may correspond to a home area code assigned to the device (i.e., as part of a device telephone number). The home geographical region 39 need not necessarily be restricted to an area code, and may instead be based upon one or more zip or postal codes, a metropolitan area, county, or based upon an imaginary boundary extending a certain distance from a central location (e.g., the user's house, etc.), as will be appreciated by those skilled in the art. In the illustrated example, the home geographical region 39 includes the user's house 41 and a coffee shop 40, although numerous other stores, the user's place of work, etc., may also be within the home geographical region as well.

The activity history may be used to determine activities or preferences of device users that the users prefer to engage in or favor at certain times of the day. In the present example, when in the home geographical region 39 the user of the device 31 regularly visits the coffee shop 40. For example, the user may regularly stop in at the coffee shop 40 on the way to work in the mornings to purchase a cup of coffee, typically between 8:00 am and 8:30 am on weekdays. The activity history module 36 may advantageously cross-reference known coordinates of stores such as the coffee shop 40 to the determined position coordinates of the device 31 to make the association that the user regularly patronizes the coffee shop 40 at this time of the morning. This is but one of many exemplary events or activity patterns that can be included in the activity history for use in determining appropriate advertising content to send to the device 31, as will be appreciated by those skilled in the art. More generally, activity may refer to or be determined based upon movement of the device 31, as well as communications (e.g., calls, emails, SMS/MMS messages, etc.) activity, as will be appreciated by those skilled in the art.

In this regard, the advertising server 35 further illustratively includes an advertising module 37 (FIG. 1) that cooperates with the activity history module 36 for selectively sending advertisements to the device 31 based upon the activity history and a given time of day. For example, the advertising module 37 may select coffee advertisements to send to the device 31 on weekdays shortly before 8:00 am, and not send coffee advertisements to the device 31 after 8:30 am because the activity history indicates that the user typically does not come in the store after this time (i.e., because the user is already at work, etc.).

Moreover, the type of advertisement may also be tailored based upon the nature of the user's activity, and whether the user is within the home geographical region 39 or not, at Block 63. For example, when in the home geographical region 39, the advertising module 37 may advantageously send home-related advertisements to the device 31, at Block 64. For example, since the user frequently visits the coffee shop 40, the advertisements need not inform the user of the shop's existence or location, but instead may be intended to remind or encourage the user to stop there, such as by relating the flavors or specials of the day.

If the device 31 is found to be outside of the home geographical region 39 by the server 35, this indicates the user is traveling, and the server may advantageously select advertisements accordingly relating to historical activities within the home geographical region at the given time of day. More particularly, when a user travels it is typically either for business purposes or entertainment/vacation purposes. In the example of FIG. 2, a user is on business travel and has taken her device 31 to a business geographical location 43, namely a downtown metro area 44. The activity history module 36 may further recognize a location as a business geographical location because it is located in an office park, an industrial area, etc., as will be appreciated by those skilled in the art. The advertising module 37 may therefore advantageously select and send work-related advertisements when the device 31 is in the business geographical location, at Block 66.

By way of example, knowing that the user likes to get coffee on the way to work, the advertising module 37 may select and send a coffee-related advertisement(s) to the device 31 around 8:00 am in the morning. However, rather than merely informing the user of the flavor of the day at their usual coffee shop 40, the advertisement now may indicate the location of, and directions to, a nearby coffee shop to the hotel the user is staying at (i.e., the user's overnight geographical location). In other words, the advertisement is tailored not only to the user's historical preferences for the given time of day, but also to the user's current location. Other business related advertisements may include restaurant offers for “sit down” business restaurants shortly before the typical time the user goes to lunch, etc. Another example is that if there is a coffee shop similar to the shop 40 the user normally frequents in the user's current location, this may be listed as an option before or after others that may be closer, in case the user prefers familiarity.

On the other hand, if the device 31 is outside of the home geographical region 39 and the activity history module 36 further determines that device is in a vacation geographical location 45 (FIG. 3), then entertainment-related advertisements may advantageously be selected and sent to the device, at Block 67, thus concluding the method illustrated in FIG. 5 (Block 68). By way of example, vacation geographical location 45 may include an amusement park 46, a national park, ski resort, etc. Thus, for example, in the morning before 8:00 am, if the device 31 is in the vicinity of an amusement park, then it may be assumed that the user is traveling with his or her family and may preferably want to go to a diner where other members of the family (e.g., children) can have breakfast, but the user can still have coffee. As such, an advertisement for a nearby diner or breakfast restaurant may be selected and sent shortly before 8:00 am in the morning, with perhaps a “kids eat free” coupon or other appropriate content.

It should be noted that in some embodiments the device 31 may have an option for user selection of location, such as home, vacation travel, and business travel. For example, the user may be permitted to set a current location through a user interface on a device display using a touch screen, keypad, etc. In such embodiments, the advertising server 35 would advantageously retrieve the current location setting from the device 31 and make the appropriate advertisement selection based thereon, as described above. When selecting “vacation,” the user may also be provided with an option for “with children” or “without children,” in some embodiments.

Advertisements may be selected in various ways. An advertising service that maintains the advertising server 35, for example, may solicit advertisements from various stores, merchants, etc., in different geographical locations, and georeference the advertisements to respective geographical positions of the stores, etc. The advertising server 35 therefore has a database of available advertisements to use based upon the given location of a user device 31 at a particular time of day, as well as current events in the given location, for example. Moreover, various techniques may be used for prioritizing the advertisements for sending to the device 31 beyond whether it is intended for users within or outside of their respective home geographical regions 39. For example, add priority may also be established based upon a bidding system, such that advertisers willing to pay more for an advertisement have their ads sent to devices first, as will be appreciated by those skilled in the art.

A related computer-readable medium is also provided. The computer-readable medium may have computer-executable instructions (or modules) for causing a computer, such as the server 35, to perform steps including generating an activity history for one or more wireless communications devices 31 including geographical positions thereof at corresponding times of day, and selectively sending advertisements to the device(s) based upon the activity history and a given time of day, as discussed further above. The advertising server 35 may include hardware components (e.g., a processor(s), memory, etc.), software components, or both. Moreover, the various functions of the server 35 described herein may be implemented in a single server device, or over a plurality of server devices, which may or may not be remotely located from one another, as will be appreciated by those skilled in the art.

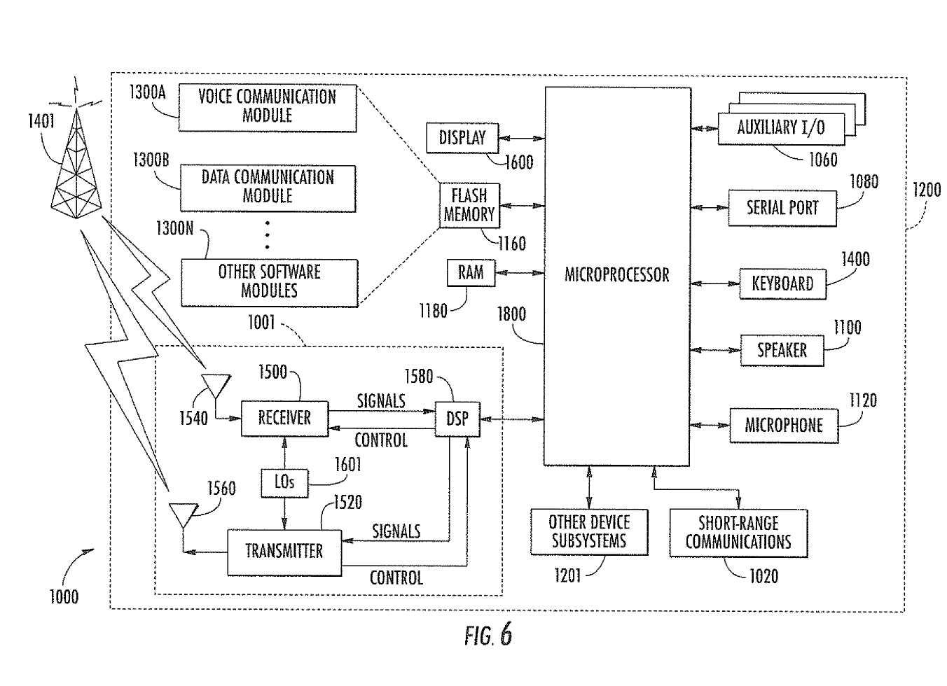

Exemplary components of a mobile wireless communications device 1000 that may be used in accordance with the system 30 are further described in the example below with reference to FIG. 6. The device 1000 illustratively includes a housing 1200, a keypad 1400 and an output device 1600. The output device shown is a display 1600, which may comprise a full graphic LCD. In some embodiments, display 1600 may comprise a touch-sensitive input and output device. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user. In some embodiments, keypad 1400 may comprise a physical keypad or a virtual keypad (e.g., using a touch-sensitive interface) or both.

The housing 1200 may be elongated vertically, or may take on other sizes and shapes (including clamshell housing structures). The keypad 1400 may include a mode selection key, or other hardware or software for switching between text entry and telephony entry.

In addition to the processing device 1800, other parts of the mobile device 1000 are shown schematically in FIG. 6. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having voice and data communications capabilities. In addition, the mobile device 1000 may have the capability to communicate with other computer systems via the Internet.

Operating system software executed by the processing device 1800 may be stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TACT or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3G, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore utilizes a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, track ball, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth™ communications module to provide for communication with similarly-enabled systems and devices.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A communications system comprising:
at least one mobile wireless communications device; and
an advertising server communicating with said at least one mobile wireless communications device via a wireless communications network and configured to
generate an activity history for said at least one wireless communications device including geographical positions at corresponding times of day based upon activity within a first geographical region,
determine whether the at least one mobile wireless communications device is within the first geographical region or at a different location outside of the first geographical region,
selectively send advertisements to said at least one mobile wireless communications device based upon the activity history and a given time of day when the at least one mobile wireless communications device is within the first geographical region, and
selectively send advertisements to said at least one mobile wireless communications device based upon the activity history within the first geographical region, a given time of day and the different location, when the at least one mobile wireless communications device is at the different location outside of the first geographical region.

2. The communications system of claim 1 wherein if said at least one mobile wireless communications device is outside of the first geographical region, then said advertising server further determines whether said at least one mobile wireless communications device is in a business geographical location or a vacation geographical location and further selectively sends the advertisements based thereon.

3. The communications system of claim 2 wherein said advertising server is configured to selectively send entertainment-related advertisements when said at least one mobile wireless communications device is in the vacation geographical location.

4. The communications system of claim 2 wherein said advertising server is configured to selectively send work-related advertisements when said at least one mobile wireless communications device is in the business geographical location.

5. The communications system of claim 1 wherein said advertising server is configured to selectively send the advertisements also based upon current events at a location of the at least one mobile wireless communications device.

6. The communications system of claim 1 wherein the activity history is based upon movement of said at least one mobile wireless communications device.

7. The communications system of claim 1 wherein the activity history is based upon wireless communications of said at least on mobile wireless communications device.

8. The communications system of claim 1 wherein said at least one mobile wireless communications device comprises a satellite positioning system; and wherein said advertising server determines the geographical positions based upon the satellite positioning system.

9. The communications system of claim 1 wherein said at least one mobile wireless communications device comprises a cellular device; wherein the wireless communications network comprises a cellular network comprising a plurality of base stations; and wherein said advertising server is configured to determine the geographical positions based upon a given base station communicating with said cellular device.

10. An advertising server for communicating with at least one mobile wireless communications device via a wireless communications network and comprising:
a memory and a processor cooperating therewith, said processor configured to
generate an activity history for the at least one wireless communications device including geographical positions at corresponding times of day based upon activity within a first geographical region,
determine whether the at least one mobile wireless communications device is within the first geographical region or at a different location outside of the first geographical region, and
selectively send advertisements to said at least one mobile wireless communications device based upon the activity history and a given time of day when the at least one mobile wireless communications device is within the first geographical region, and
selectively send advertisements to said at least one mobile wireless communications device based upon the activity history within the first geographical region, a given time of day and the different location, when the at least one mobile wireless communications device is outside of the first geographical region.

11. The advertising server of claim 10 wherein processor is further configured to determine whether the at least one mobile wireless communications device is in a business geographical location or a vacation geographical location if the at least one mobile wireless communications device is outside of the first geographical region, and further selectively send the advertisements based thereon.

12. The advertising server of claim 11 wherein said processor is configured to selectively send entertainment-related advertisements when the at least one mobile wireless communications device is in the vacation geographical location.

13. The advertising server of claim 11 wherein said processor is configured to selectively send work-related advertisements when the at least one mobile wireless communications device is in the business geographical location.

14. A communications method comprising:
generating an activity history for at least one wireless communications device including geographical positions thereof at corresponding times of day using an advertising server based upon activity within a first geographical region;
determining whether the at least one mobile wireless communications device is within the first geographical region or at a different location outside of the first geographical region; and
selectively sending advertisements to the at least one mobile wireless communications device based upon the activity history and a given time of day using the advertising server when the at least one mobile wireless communications device is within the first geographical region; and
selectively send advertisements to said at least one mobile wireless communications device based upon the activity history within the home geographical region, a given time of day and the different location, using the advertising server, when the at least one mobile wireless communications device is outside of the first geographical region.

15. The method of claim 14 wherein determining if the at least one mobile wireless communications device is outside of the home geographical region using the advertising server includes determining whether the at least one mobile wireless communications device is in a business geographical location or a vacation geographical location using the advertising server; and wherein selectively sending advertisements comprises selectively sending based upon whether the at least one mobile wireless communications device is in the business geographical location or the vacation geographical location.

16. The method of claim 15 wherein selectively sending further comprises sending entertainment-related advertisements when the at least one mobile wireless communications device is in the vacation geographical location.

17. The method of claim 16 wherein selectively sending further comprises sending work-related advertisements when the at least one mobile wireless communications device is in the business geographical location.

18. A non-transitory computer-readable medium having computer-executable instructions for causing a computer to perform steps comprising:
generating an activity history for at least one wireless communications device including geographical positions thereof at corresponding times of day based upon activity within a first geographical region;
determining whether the at least one mobile wireless communications device is within the home geographical region or at a different location outside of the first geographical region; and
selectively sending advertisements to the at least one mobile wireless communications device based upon the activity history and a given time of day when the at least one mobile wireless communications device is within the first geographical region; and
selectively send advertisements to said at least one mobile wireless communications device based upon the activity history within the first geographical region, a given time of day and the different location when the at least one mobile wireless communications device is outside of the first geographical region.

19. The non-transitory computer-readable medium of claim 18 further comprising computer-executable instructions for causing the computer to determine if the at least one mobile wireless communications device is in a business geographical location or a vacation geographical location; and wherein selectively sending comprises selectively sending based upon whether the at least one mobile wireless communications device is in the business geographical location or the vacation geographical location.

20. The non-transitory computer-readable medium of claim 19 wherein selectively sending further comprises sending entertainment-related advertisements when the at least one mobile wireless communications device is in the vacation geographical location.

21. The non-transitory computer-readable medium of claim 19 wherein selectively sending further comprises sending work-related advertisements when the at least one mobile wireless communications device is in the business geographical location.
